(19) United States
(12) Patent Application Publication
(10) Pub. No.: US 2026/0350646 A1
(43) Pub. Date: Nov. 5, 2026

(54) METHOD FOR MONITORING AND IDENTIFYING TRACKED ASSETS BASED ON PUBLIC ATTENTION

(71) Applicant: Corey Chandler, Lac Du Bonnet (CA)

(72) Inventor: Corey Chandler, Lac Du Bonnet (CA)

(21) Appl. No.: 19/658,695

(22) Filed: Apr. 26, 2026

Related U.S. Application Data
(60) Provisional application No. 63/797,876, filed on Apr. 30, 2025.

(51) Int. Cl. G06Q 30/0201; G06Q 10/40

(52) U.S. Cl. CPC G06Q 30/0206; G06Q 10/40

(57) ABSTRACT

A computer-implemented system, method, and computer-readable medium are disclosed for monitoring a tracked asset using a Buzz value associated with the tracked asset. A default Buzz value and an evaluation interval are established for the tracked asset. During the evaluation interval, activity data associated with the tracked asset is processed to determine a current Buzz value representing quantified public attention associated with the tracked asset. Output data, including graphical displays, may represent the current Buzz value and a price value of the tracked asset relative to time. When the evaluation interval expires, the current Buzz value is reset to the default Buzz value while the price value is retained and associated with the default Buzz value for a succeeding evaluation interval. Repetition of successive evaluation intervals provides standardized interval-by-interval tracking of Buzz and price for the tracked asset.

### FIELD OF THE INVENTION

The present invention is generally directed to methods of monitoring and identifying tracked assets using data associated with public attention. More specifically, the invention relates to methods of determining, quantifying, and displaying a Buzz value associated with a tracked asset relative to price and time over one or more evaluation intervals.

### BACKGROUND OF THE INVENTION

The present invention relates generally to monitoring and identifying tracked assets using data associated with public attention and related activity.

In digital environments, large volumes of information are continuously generated across online platforms, media channels, and networked services. As a result, attention associated with a topic, asset, or subject may fluctuate significantly over time. In some contexts, including digital-asset markets and other rapidly changing environments, such fluctuations in public attention may occur over relatively short intervals.

Certain assets, including digital assets, cryptocurrencies, memecoins, stocks, bonds, and other tracked assets, may be associated with changing levels of public attention reflected through activity occurring across one or more data sources. Existing systems may provide price information, charting tools, or general analytics, but such systems do not provide a standardized mechanism for determining, tracking, and presenting a value associated with public attention separately from price over successive intervals.

In particular, existing systems do not adequately provide a framework in which a value associated with public attention can be determined during a defined interval, presented relative to price and time, and then reset to a default value for a succeeding interval while retaining the price value associated with the tracked asset. As a result, comparisons of attention-related activity across successive intervals may be inconsistent or difficult to standardize.

Accordingly, there remains a need for systems and methods for monitoring and identifying tracked assets using a Buzz value associated with quantified public attention, wherein the Buzz value may be determined from activity data associated with the tracked asset, displayed relative to a price value and time, and reset to a default value for successive evaluation intervals while retaining the price value associated with the tracked asset.

### SUMMARY OF THE INVENTION

In one embodiment, a computer-implemented method monitors a tracked asset by establishing a default Buzz value and an evaluation interval for the tracked asset, obtaining activity data associated with the tracked asset during the evaluation interval, determining from the activity data a current Buzz value representing quantified public attention associated with the tracked asset, and generating output data representing the current Buzz value and a price value of the tracked asset relative to time.

In one embodiment, the Buzz value is maintained as a value separate from the price value. The activity data used to determine the Buzz value may be obtained from one or more data sources associated with the tracked asset, including, by way of example, social media sources, news sources, sentiment analysis platforms, social listening tools, news aggregators, on-chain analytics platforms, website or forum monitoring tools, and API-based data providers.

When the evaluation interval expires, the current Buzz value is reset or rebased to the default Buzz value, while the price value at the end of the evaluation interval is retained and associated with the default Buzz value for a succeeding evaluation interval. In this manner, successive evaluation intervals may be presented from a standardized Buzz starting point while preserving price continuity from interval to interval.

The output data may comprise data records, graphical displays, or both. In some embodiments, the graphical output presents Buzz and price relative to time using separate representations for Buzz and price. The graphical output may be provided as a line graph, bar graph, scatterplot, or candlestick chart. In some embodiments, captured data and graphical output are stored, exported, or compiled into an output file, including a PDF document or spreadsheet.

### BRIEF DESCRIPTION OF THE DRAWINGS

FIG. 1 is a schematic block diagram of a method of monitoring and identifying tracked assets using a Buzz value associated with quantified public attention, in accordance with at least one embodiment of the present invention.

FIG. 2a is a graphical display of an evaluation interval during which activity data associated with a tracked asset is collected, processed, and displayed, in accordance with at least one embodiment of the present invention.

FIG. 2b is a graphical display comparing a first evaluation interval to a succeeding evaluation interval following a reset of the Buzz value, in accordance with at least one embodiment of the present invention.

FIG. 2c is a graphical display of a succeeding evaluation interval following a reset of the Buzz value, in accordance with at least one embodiment of the present invention.

FIG. 2d is a graphical display using a candlestick chart format for presenting data associated with an evaluation interval, in accordance with at least one embodiment of the present invention.

FIG. 3a is a two-dimensional drawing of a physical apparatus configured to perform an evaluation-interval monitoring procedure, in accordance with at least one embodiment of the present invention.

FIG. 3b is a two-dimensional drawing of an alternative physical apparatus embodiment, in accordance with at least one embodiment of the present invention.

FIG. 4a is a flowchart of a method of using the physical apparatus to monitor and identify tracked assets using a Buzz value associated with quantified public attention, in accordance with at least one embodiment of the present invention.

FIG. 4b is a flowchart of a method of using the physical apparatus to monitor and identify tracked assets using a Buzz value associated with quantified public attention, in accordance with at least one embodiment of the present invention.

Like reference numerals refer to like parts throughout the several views of the drawings provided herein.

### DETAILED DESCRIPTION OF THE INVENTION

It is important to note that the embodiments disclosed herein are illustrative and non-limiting. In general, statements made in this specification do not necessarily limit any of the various claimed embodiments. Moreover, some statements may apply to some inventive features but not to others. Unless otherwise indicated, singular elements may be in plural and plural elements may be in singular without departing from the disclosed subject matter. In the drawings, like numerals refer to like parts throughout the several views.

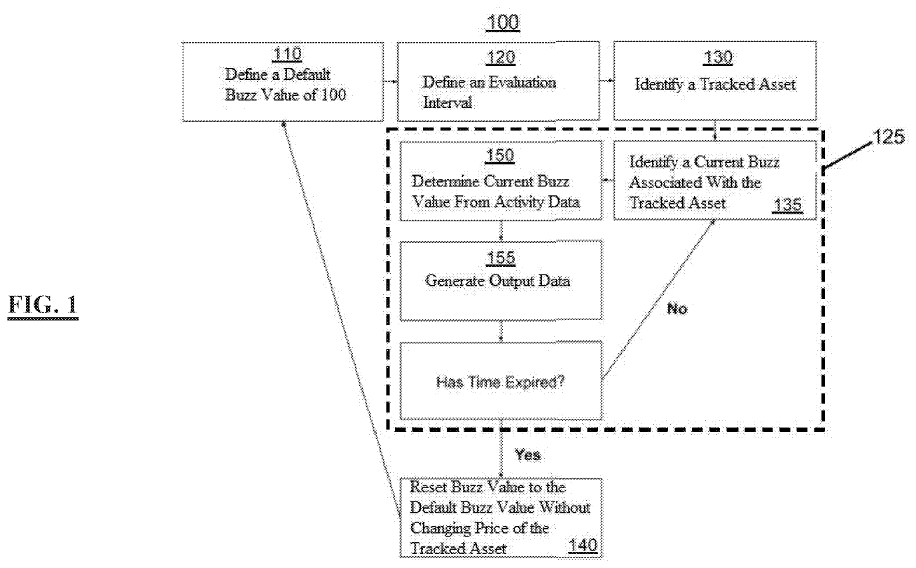

As shown in the accompanying drawings, and with particular reference to FIG. 1, at least one embodiment of the present invention is directed to a method 100 of monitoring and identifying a tracked asset using a Buzz value associated with public attention. In at least one embodiment, the method 100 includes defining a default Buzz value 110. The default Buzz value may be any selected numeric reference. For purposes of explanation, the default Buzz value may be defined as one hundred (100). In at least one embodiment, the default Buzz value 110 provides a baseline from which changes in Buzz associated with the tracked asset may be followed during an evaluation interval.

Still referring to FIG. 1, the method 100 of at least one embodiment also includes defining an evaluation interval 125 for the tracked asset. The evaluation interval 125 may be any selected duration, including seconds, minutes, hours, days, weeks, months, years, or another selected period.

Furthermore, as shown in FIG. 1, the method 100 also includes identifying or selecting a tracked asset 130 for the evaluation interval 125 to be applied to. The tracked asset 130 may be selected from any number of asset types, including a digital asset, cryptocurrency, memecoin, stock, bond, betting application or service, or another asset having an associated price value.

Once the tracked asset 130 is identified, the method 100 of at least one embodiment is configured to monitor, identify, or otherwise determine a current Buzz value associated with the tracked asset 130. This may be accomplished in a number of ways, including by monitoring social media websites or services, news outlets or articles, website or forum activity, on-chain analytics, API-based data sources, or other activity data associated with the tracked asset 130.

For instance, in at least one embodiment, one or more system parameters may be assigned in order to track the amount of public attention associated with the tracked asset 130, which is referred to herein as Buzz 135. The system parameters may include factors used in quantifying, recognizing, searching, finding, or otherwise tracking Buzz and related activity associated with the tracked asset. As an example, the system parameters may be applied to one or more third-party systems, such as a sentiment analysis platform, social listening tool, news aggregator, on-chain data and analytics platform, website or forum monitoring tool, API or data provider, or another information source. Applying these system parameters to the third-party systems enables the collection of information about how the tracked asset 130 receives public attention, including one or more buzz events 136. A buzz event 136 may occur whenever the tracked asset 130 receives attention in the form of discussion, retweeting, posting, sharing, news coverage, or other activity associated with the tracked asset 130.

Next, as shown in FIG. 1, the method 100 of at least one embodiment also includes determining a current Buzz value to quantify the current Buzz 135, as shown at block 150. In other words, once the current Buzz 135 is determined or estimated, the system and/or method will quantify that Buzz 135 by assigning a current Buzz value. For example, if the default Buzz value is set at 100 and the current Buzz 135 is higher than previously recorded or has increased during the evaluation interval, then the current Buzz value may be higher than 100. Conversely, if the current Buzz 135 appears to be lower than previously determined or has decreased, then the current Buzz value may be lower than 100.

Still referring to FIG. 1, the method 100 of at least one embodiment is configured to generate output data 155, for example in the form of data records, graphical displays, or both, as described further herein.

If the evaluation interval 125 has not yet expired, the process of identifying the current Buzz 135, determining a current Buzz value 150 associated with the current Buzz 135, and generating output data 155 continues, as represented in FIG. 1.

When, however, the evaluation interval 125 has expired, then as shown at 140, in at least one embodiment the current Buzz value is reset or rebased to the default Buzz value without changing the price 160 of the tracked asset, as provided in more detail below.

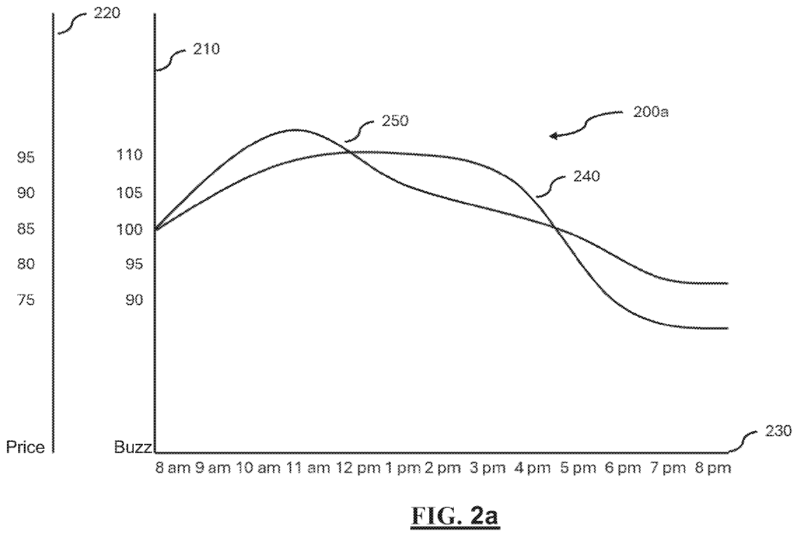

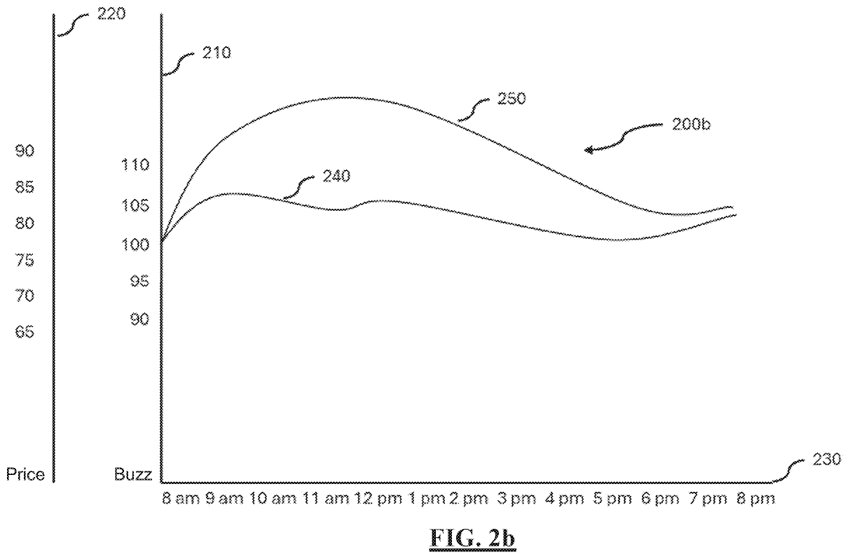

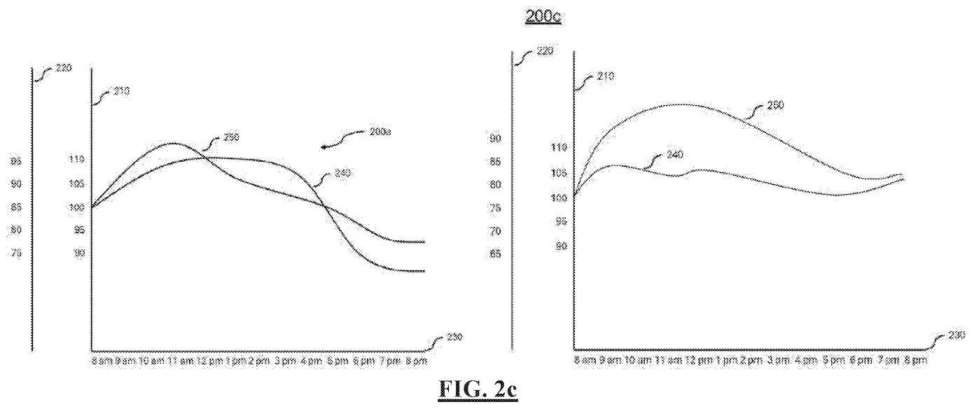

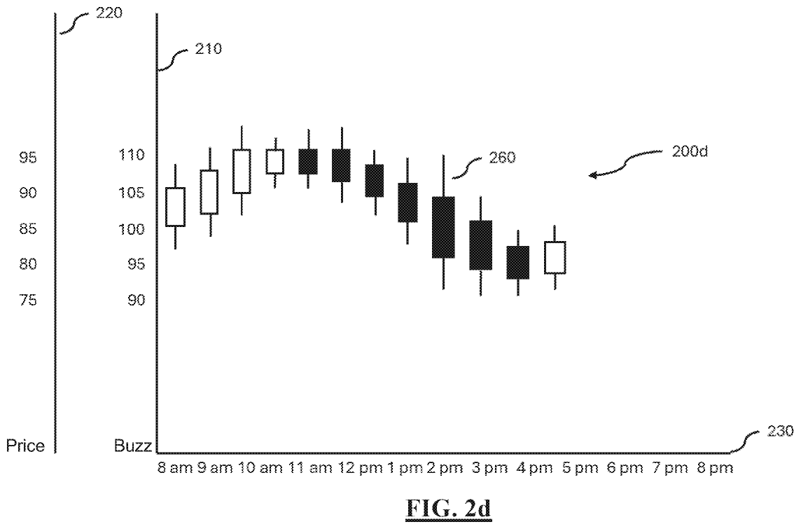

Referring now to FIGS. 2a, 2b, 2c, and 2d, several exemplary graphical displays 200a-d are shown, as disclosed in several embodiments of the present invention.

More specifically, in at least one embodiment, the graphical display 200a-d has two y-axes and one x-axis. One of the y-axes 210 is representative of Buzz, whereas the other y-axis 220 is representative of a price 160 of the tracked asset 130. The price 160 is the current market-value price of the tracked asset 130.

Moreover, in the example shown, the x-axis 230 of the graphical display 200a-d is used to represent time. As time elapses along the x-axis 230, the amount of Buzz 135 is displayed, starting at the previously assigned default Buzz value (e.g., 100) and fluctuating up and/or down based on the system parameters or otherwise based on the current Buzz as determined by the system and method. As Buzz 135 and price 160 change over time, the graphical display may present corresponding changes in those values, but not necessarily in an equal or fixed manner.

It should also be noted that the orientation and/or layout of the various exemplary graphical displays shown in FIGS. 2a-d are for illustrative purposes only and should not be considered limiting. Other embodiments of the present invention may generate output displays that are organized in a different manner.

Furthermore, in some embodiments, the third-party system registers the number of buzz events 136 associated with the tracked asset 130, with the default Buzz value 110 being set to 100 as the baseline value. As the number or significance of buzz events 136 changes, a Buzz indication line 240 may adjust relative to the baseline value. A corresponding price indication line 250 may also be displayed to represent the price 160 of the tracked asset 130. In another embodiment, the graphical display 200 implements the use of a candlestick-style display 260.

Furthermore, in at least one embodiment, upon completion of the evaluation interval 125, a succeeding evaluation interval is initiated. Upon doing so, the current Buzz value is reset 140 to the default Buzz value 110, which in the example provided above is 100.

However, at the end of the evaluation interval 125, the price 160 listed at the end of the evaluation interval 125 and presented on the display is retained and used as the price 160 associated with the reset default Buzz value 110.

As one example, assume the default Buzz value is set to 100, and at the end of the evaluation interval the current Buzz value is 110.52 and the price 160 is $78.62. Then, at the start of the succeeding evaluation interval 125, the Buzz value is reset 140 to 100, although the price remains the same at $78.62.

By resetting the end value of 110.52 to 100, the user is able to start each evaluation interval 125 from a standardized point, thereby creating an easily recognizable display of activity during a particular evaluation interval 125. In some embodiments, the second y-axis 220 corresponding to price may be shifted or realigned so that the last known price 160 of the prior evaluation interval 125 corresponds to the default Buzz value 110 on the first y-axis 210. The realigned price value allows users to know what the price 160 was when the previous evaluation interval 125 ended.

In some embodiments, each individual buzz event 136 is assigned an equal value. This means that regardless of the type of buzz event 136 that occurs, the same value is assigned.

In another embodiment, individual buzz events 136 may be assigned different weighted values based on one or more factors. These weighted values may be used to account for the disproportionate manner in which particular buzz events 136 can affect public attention associated with the tracked asset 130. Buzz events 136 that have a greater chance of affecting public attention associated with the tracked asset 130 may be referred to as significant buzz events 137. A significant buzz event 137 may result from a public statement, media mention, social-media post, reported earnings, release of a new technology, or other event associated with the tracked asset 130.

As the buzz events 136 occur, they are collected by the third-party systems for processing. As the third-party system collects the information, it may either assign the equal value to all events or assign a weighted value to the event based on the system parameters assigned at the outset of the method. As values are assigned to the buzz events 136, they may be analyzed before tallying. One example includes the use of a sentiment analysis platform to assess the volume of Buzz surrounding the tracked asset 130 at a given period in time, followed by assigning a sentiment score. The sentiment score may be positive, neutral, or negative in nature depending on the analyzed buzz events, and may itself be weighted based on the likelihood that it will affect public attention associated with the tracked asset 130.

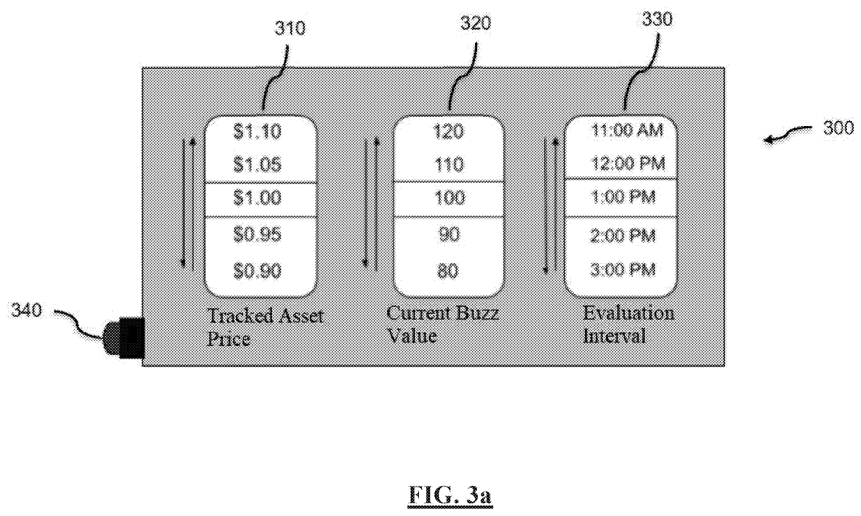

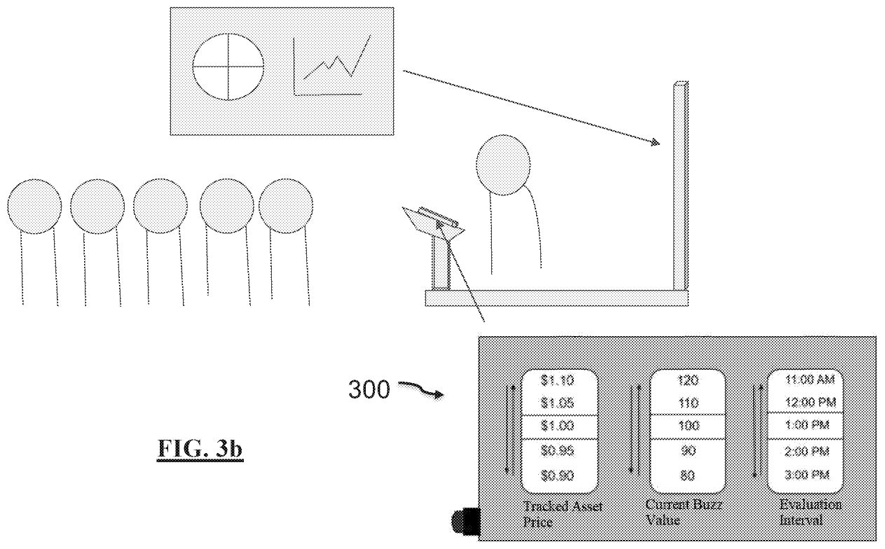

Referring now to FIGS. 3a and 3b, in at least one embodiment, the present invention includes an apparatus or device, generally referenced as 300, capable of implementing several steps of the method 100 disclosed above.

For instance, the apparatus 300 of at least one embodiment includes a plurality of modules or controls 310, 320, 330 that are each configured to move, rotate, update, or otherwise indicate or display a different feature or component of the system and method. In particular, the columns or modules 310, 320, 330 of at least one embodiment serve to visually and mechanically represent data transitions, such as the tracked-asset price, Buzz value, and/or evaluation interval. Each individual column or module 310, 320, 330 may provide a tangible and intuitive interface for users to observe and interact with evolving information.

It should be noted that in some embodiments the plurality of columns or modules are interchangeable to account for different data visualizations or representations. Furthermore, the columns or modules 310, 320, 330 may be analog displays, digital displays, rotational wheels, slides, or similar components that can be adjusted by input buttons on the apparatus 300, controlled through a connected device, or otherwise manipulated through user input.

In any event, in several embodiments, including the exemplary embodiment illustrated in FIG. 3a, the configuration of the device 300 enables efficient data tracking and presentation within a portable format.

Referring to FIGS. 3a and 3b, at least one column or module 310 of the device 300 represents the current market-value price 160 of the tracked asset 130. This column or module may update to reflect changes in price 160 of the tracked asset 130.

In some embodiments, at least one column or module, such as the second column 320, represents the current Buzz value. Specifically, the current Buzz value module 320 of at least one embodiment represents the current public attention associated with the tracked asset 130 at a given time during the evaluation interval 125. As provided above, in some embodiments, the Buzz value 135 may be derived from one or more third-party data sources. These may include sentiment analysis platforms, social listening tools, news aggregators, on-chain data and analytics platforms, as well as monitoring tools for websites, forums, and APIs providing data feeds. Once gathered, this information may be processed to generate a quantifiable measure of attention associated with the tracked asset.

Accordingly, the current Buzz value column or module 320 displays this quantified attention in a visual format by adjusting to reflect fluctuations in the Buzz value 135. This dynamic representation enables the user to observe the current state of public attention surrounding the tracked asset 130.

Furthermore, the evaluation-interval column or module 330 of at least one embodiment enables the user to indicate the passage of time. For example, in some embodiments the user may choose a one-day period, during which the apparatus 300 will display the hours of a day while tracking the Buzz associated with the particular tracked asset 130. Throughout the selected time frame, the user may monitor and update the current Buzz value column 320 to reflect changes in public attention associated with the tracked asset 130. Simultaneously, the tracked-asset price column 310 may display changes in the corresponding price 160 related to the tracked asset 130. By setting a defined evaluation interval 125 using the evaluation-interval column 330, the device facilitates temporal monitoring and data visualization.

It should also be noted that the order in which the columns or modules are provided on the device 300, or otherwise the particular layout of the device 300, should not be considered limiting in that other layouts and organizations of the modules are contemplated within the full spirit and scope of the present invention.

Furthermore, some embodiments also include a physical reset button 340, which serves a function in recalibrating the device 300 for a new evaluation interval 125. When activated, the reset button 340 causes the existing current Buzz value displayed on column 320 to return to its starting value or to the default Buzz value, such as 100 in the example above.

Additionally, upon activation of the reset button 340, the selected evaluation interval column 330 is reset to a default interval value. This enables the user to initiate a new evaluation interval 125. The reset function does not alter the tracked-asset price column 310 when pressed. By preserving the current price 160 while resetting the Buzz 135 and the evaluation interval 125, the device 300 maintains a monitoring system for the tracked asset 130. In alternative embodiments, the reset button 340 need not be a physical button and may instead be implemented through a computer or software connection.

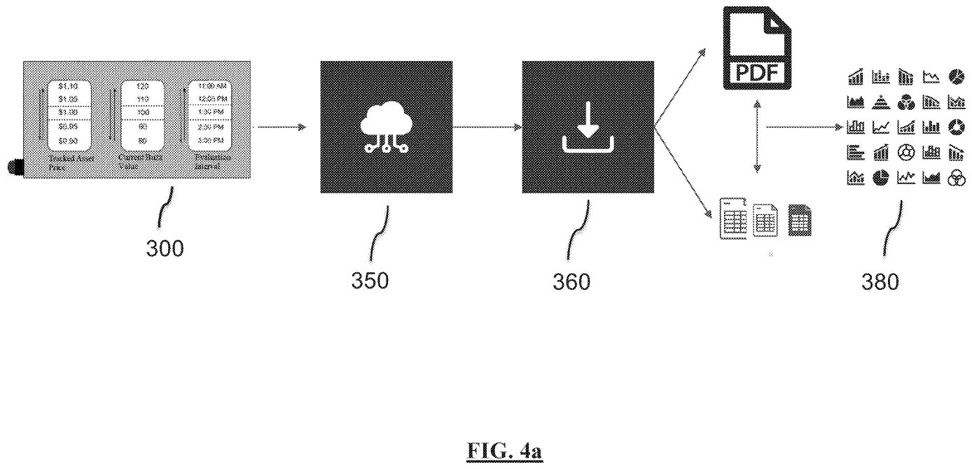

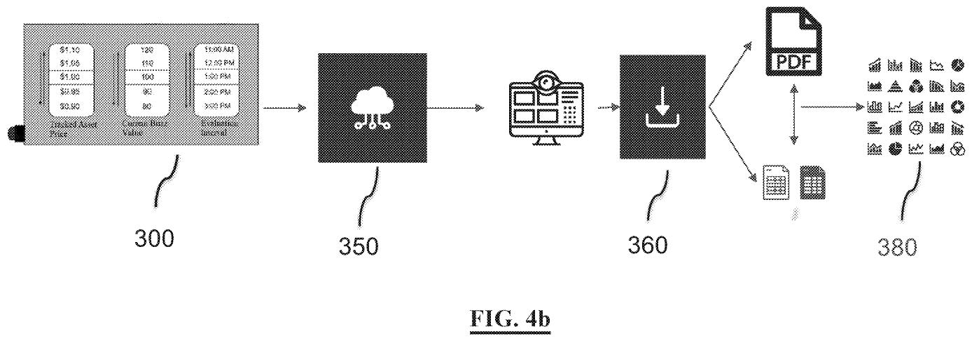

In some embodiments, the physical apparatus 300, referring to FIGS. 4a and 4b, may communicate with a server to transmit information and store tracked-asset information on a cloud-based server 350. The stored information can then be downloaded to various devices, including tablets, laptops, desktops, or mobile phones, either directly or through a dedicated application. The downloaded data may be provided in formats such as PDF documents and/or spreadsheets, which present the recorded outputs, including changes in variables such as the price 160 and the Buzz value 135, during the evaluation interval 125. These files may also include corresponding visual representations of the data, such as candlestick charts, bar graphs, scatterplots, and/or line graphs, to facilitate analysis and interpretation.

In addition to storing and exporting the data, the application on the tablet, laptop, desktop, or mobile phone may provide visualization of the data during the evaluation interval 125. This enables users to monitor changes in the price 160 and the Buzz value 135 throughout the duration of the evaluation interval 125. Once the evaluation interval 125 concludes, the application may automatically generate a PDF and/or spreadsheet file 360 containing the captured data along with associated graphical representations 380, thereby providing a record of the evaluation interval 125.

In another embodiment, the method may be executed on or via an electronic device, eliminating the need for a separate physical apparatus 300. Specifically, the complete method described herein may be implemented within a standalone software application that can be downloaded onto a laptop, desktop computer, tablet, or mobile device. While the fundamental steps of the method remain unchanged, the processes related to storing, processing, and uploading the collected information may be managed directly through the application.

In certain embodiments, the application itself may display and store the resulting data, such as spreadsheets and graphical outputs, allowing users to view, analyze, and manage the information in the application. These graphs may include candlestick charts, bar graphs, scatterplots, and line graphs.

In other embodiments, the application may provide functionality to export the information into external file formats, such as PDF documents or spreadsheet files, for offline access, further analysis, or sharing. This allows for enhanced flexibility and interoperability with other platforms and software commonly used in data review and reporting workflows.

In some embodiments, the columns described herein, such as the tracked-asset price column 310, the current Buzz value column 320, and the evaluation-interval column 330, may be implemented as digital rather than physical structures. These digital displays may simulate the functionality and appearance of physical columns through interactive interfaces. The user may interact with the digital columns through touch, mouse input, or other interface controls to rotate, adjust, or otherwise manipulate the display. This embodiment allows flexibility in presentation, customization of visual elements, and integration with software-driven data collection and analysis.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention. This written description provides an illustrative explanation of the present invention. It may be possible to deliver equivalent benefits using variations of the specific embodiments without departing from the inventive concept. This description and these drawings, therefore, are to be regarded as illustrative and not restrictive.

### DEFINITIONS/TERMINOLOGY

### Tracked Asset

As used herein, “tracked asset” refers to an identified asset selected for monitoring under the disclosed method. The tracked asset may be identified by a name, ticker, or other asset identifier and may include, by way of example, a digital asset, cryptocurrency, memecoin, stock, bond, or other attention-based asset having an associated price value.

### Buzz/Buzz Value

As used herein, “Buzz” or “Buzz value” refers to a quantified value representing public attention associated with a tracked asset. The Buzz value is determined from activity data associated with the tracked asset and is maintained as a value separate from price.

### Buzz Event

As used herein, a “Buzz event” refers to an occurrence indicating attention associated with a tracked asset, including, by way of example, discussion, posting, retweeting, sharing, news coverage, or similar attention-related activity associated with the tracked asset.

### Default Buzz Value/Baseline Buzz Value

As used herein, “default Buzz value” or “baseline Buzz value” refers to a reference Buzz value used at the beginning of an evaluation interval. The default Buzz value may be any selected numeric reference and, in some embodiments, is 100.

### Evaluation Interval

As used herein, “evaluation interval” refers to a defined time segment over which Buzz and price associated with a tracked asset are monitored before a reset or rebasing event. The evaluation interval may be user-defined or predetermined and may be expressed in seconds, minutes, hours, days, weeks, months, years, or another selected duration.

### Output Data

As used herein, “output data” refers to data records, graphical displays, or both, representing Buzz and price associated with a tracked asset relative to time during an evaluation interval.

### Reset/Rebasing

As used herein, “reset” or “rebasing” refers to returning a current Buzz value to the default Buzz value at the conclusion of an evaluation interval while retaining the price value associated with the tracked asset for use in a succeeding evaluation interval.

### EMBODIMENTS AND VARIATIONS

### Optional Narrower Embodiment—Event Weighting and Sentiment

In some embodiments, buzz events associated with the tracked asset are assigned equal values before being tallied. In other embodiments, at least some buzz events are assigned different weights based on an expected likelihood that the event will affect public attention associated with the tracked asset. In some embodiments, a sentiment score may be assigned to at least some buzz events before tallying, including a positive, neutral, or negative sentiment score.

Optional Narrower Embodiment—Purchase-Related Activity

In some embodiments, the activity data used to determine the current Buzz value may additionally include data indicative of a rise or fall of purchases associated with the tracked asset. In such embodiments, that information is considered as one source of information associated with the tracked asset, while the Buzz value remains distinct from the price value itself.

1. A computer-implemented method executed by one or more processors, the method comprising:
identifying a tracked asset;
storing, in memory, a default Buzz value for the tracked asset and a price value associated with the tracked asset;
defining an evaluation interval for the tracked asset;
during the evaluation interval:
obtaining activity data associated with the tracked asset, the activity data including attention-related activity associated with the tracked asset;
processing the activity data to determine a current Buzz value for the tracked asset, the current Buzz value representing quantified public attention associated with the tracked asset and being maintained separately from the price value; and
generating output data representing, relative to time within the evaluation interval, the current Buzz value and the price value;
upon expiration of the evaluation interval, resetting, in memory, the current Buzz value to the default Buzz value while retaining the price value and associating the retained price value with the default Buzz value for a succeeding evaluation interval; and
repeating the obtaining, processing, generating, resetting, retaining, and associating for successive evaluation intervals.

2. The method of claim 1, wherein the default Buzz value is 100.

3. The method of claim 1, wherein defining the evaluation interval comprises receiving input specifying at least one of a start time, an end time, or a duration, and wherein the duration is selected from seconds, minutes, hours, days, weeks, months, and years.

4. The method of claim 1, wherein the tracked asset is identified by a name, ticker, or other asset identifier and comprises a digital asset, cryptocurrency, memecoin, stock, or bond.

5. The method of claim 1, wherein obtaining the activity data comprises applying one or more system parameters to at least one third-party data source selected from a social media website or service, a news outlet or article source, a sentiment analysis platform, a social listening tool, a news aggregator, an on-chain data or analytics platform, a website or forum monitor, and an API or data provider.

6. The method of claim 1, wherein processing the activity data comprises detecting buzz events associated with the tracked asset and assigning values to the buzz events before tallying the buzz events.

7. The method of claim 6, wherein each detected buzz event is assigned an equal value.

8. The method of claim 6, wherein at least some detected buzz events are assigned different weights, and wherein at least some detected buzz events are assigned a sentiment score selected from positive, neutral, and negative before tallying.

9. The method of claim 1, further comprising rendering, from the output data, a graphical display having a first y-axis corresponding to the current Buzz value, a second y-axis corresponding to the price value, and an x-axis corresponding to time.

10. The method of claim 9, wherein, at a start of the succeeding evaluation interval, the second y-axis is realigned such that the retained price value corresponds to the default Buzz value.

11. A system comprising:
a memory configured to store a default Buzz value and a price value associated with a tracked asset;
an input interface configured to receive activity data associated with the tracked asset;
a display; and
one or more processors in communication with the memory, the input interface, and the display,
wherein the one or more processors are configured to:
identify the tracked asset;
define an evaluation interval for the tracked asset;
process the activity data, including attention-related activity associated with the tracked asset, to determine a current Buzz value for the tracked asset, the current Buzz value representing quantified public attention associated with the tracked asset and being maintained separately from the price value;
generate output data representing, relative to time within the evaluation interval, the current Buzz value and the price value;
cause the display to present a graphical display generated from the output data; and
upon expiration of the evaluation interval, reset the current Buzz value to the default Buzz value while retaining the price value for association with the default Buzz value in a succeeding evaluation interval.

12. The system of claim 11, wherein the one or more processors are configured, upon expiration of the evaluation interval, to generate an output file containing captured data and at least one graphical representation of the current Buzz value and the price value.

13. The system of claim 12, wherein the output file is stored or exported as a PDF document or spreadsheet, and wherein the system is configured to communicate with a remote server or cloud-based platform to store the output file.

14. A non-transitory computer-readable medium storing instructions that, when executed by one or more processors, cause the one or more processors to:
identify a tracked asset;
store, in memory, a default Buzz value for the tracked asset and a price value associated with the tracked asset;
define an evaluation interval for the tracked asset;
obtain activity data associated with the tracked asset, the activity data including attention-related activity associated with the tracked asset;
process the activity data to determine a current Buzz value for the tracked asset, the current Buzz value representing quantified public attention associated with the tracked asset and being maintained separately from the price value;
render output data including a graphical presentation of the current Buzz value and the price value relative to time within the evaluation interval; and
upon expiration of the evaluation interval, reset the current Buzz value to the default Buzz value while retaining the price value and associating the retained price value with the default Buzz value for a subsequent evaluation interval.

15. The non-transitory computer-readable medium of claim 14, wherein the default Buzz value is 100 and wherein the instructions further cause the one or more processors to repeat successive evaluation intervals using the retained price value and the reset current Buzz value.

16. The non-transitory computer-readable medium of claim 14, wherein the graphical presentation comprises a line graph, bar graph, scatterplot, or candlestick chart, and wherein the instructions further cause the one or more processors, upon expiration of the evaluation interval, to generate an output file including the graphical presentation.
